(19) United States
(12) Patent Application Publication
(10) Pub. No.: US 2005/0035615 A1
(43) Pub. Date: Feb. 17, 2005

(54) Light bulb puller

(76) Inventor: Ralph Wessel, Cayucos, CA (US)

Correspondence Address: RALPH WESSEL, 3166 SHEARER AVE, CAYUCOS, CA, 93430, US

(21) Appl. No.: 10/756,985

(22) Filed: Jan. 13, 2004

Related U.S. Application Data
(63) Continuation-in-part of application No. 10/638,203, filed on Aug. 11, 2003.

(51) Int. Cl. B25B 7/00

(52) U.S. Cl. 294/99.2

(57) ABSTRACT

This is a tool to aid in the changing of small bulbs such as Christmas tree light bulbs. These bulbs are pressure fitted and there is no easy way to pull them from their sockets for repair or replacement.

| | | | |
|---|---|---|---|
| 6561673 | May 13, 2003 | Fredrick | 439/501 |
| 6167602 | Jan. 2, 1961 | Yang et al. | 29/278 |
| 6047464 | Mar. 11, 2000 | Chadbourne et al. | 29/274 |
| 5316512 | May 31, 1994 | Ell | 445/61; 29/764 |

### BACKGROUND

This invention was developed to fill a need to have a small tool that is easy to use when removing or replacing small Christmas tree type lamp bulbs.

The Christmas tree bulbs are small (overall size approximately. 1″) with a plastic bottom that fits tightly into a plastic receptacle or base. The plastic bottom of the lamp has a shoulder on top. This bottom fits into a base connected to the electric cord.

The difficulty occurs when it becomes necessary to replace them with a different bulb. To insure good electrical contact it is necessary that the two plastic surfaces fit together very tightly. With the small size and tight fit it becomes difficult to release the lamp from its' base. We have tried pliers, side cutters and fingernails to pry the lamp from its' base. The side cutters were the best but were too clumsy. Using one's fingernail often results in broken nails. So we put the advantage of side cutters into a small easy to use tool. This would be especially helpful for those who have difficulty due to arthritis or age. This tool was designed to do this job easily and at little manufacturing cost.

The tool may be made out of metal or plastic.

### BRIEF SUMMARY OF INVENTION

The tool consists of a simple “U” shaped unit with the top of the “U” bent inward and notched to allow it to grasp the plastic bottom of a small light bulb and extract it from its base. It could be made from metal or plastic.

New

It could also be made in a circular, oblong, rectangular, or triangular shape with or without the inward bend.

### DESCRIPTION OF THE DRAWINGS

FIG. 1—top view

FIG. 2—end view

FIG. 3—side view

FIG. 4—sketch of a hand with the tool in use.

FIG. 5—sketch of typical small bulb

FIG. 6—sketch—example of circular tool

### DETAILED DESCRIPTION

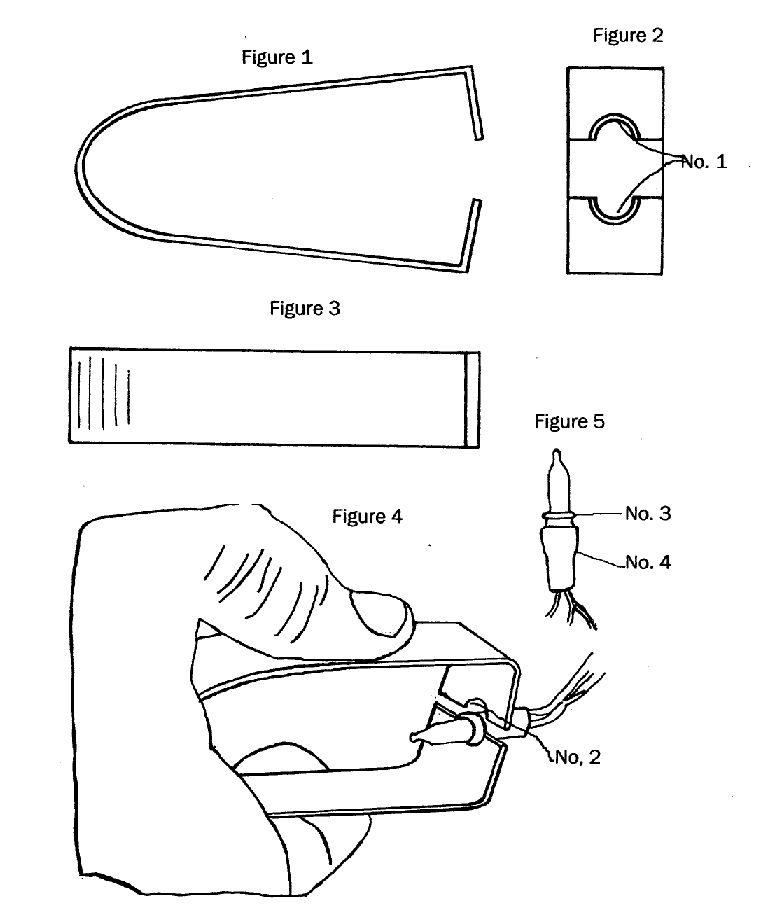

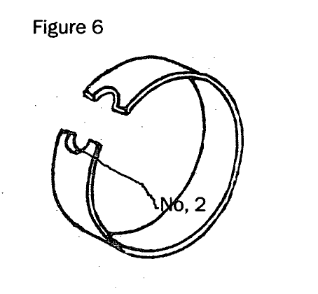

The tool consists of a flat piece of metal or a synthetic material, formed into a “U” shape with the open end of the U bent inward at 90 degrees to the side as in FIG. 1. When pressure is placed on the outside of the “U” the two ends come together. Each of the ends has a notch, as in FIG. 2, just large enough to fit around the lamp sockets in FIG. 4, No.2.

The notch can be beveled to fit in the location where the lamp bottom's shoulder FIG. 5, No.3 meets the base FIG. 5, No.4.

Side pressure on the tool compresses the tool and clamps onto the lamp base. A slight outward pull releases the lamp from its base. Releasing the side pressure on the tool allows the lamp to be released. A very simple and effective movement.

The tool should be made with just enough stiffness or spring to return to its' original shape when pressed as shown in FIG. 4 but still be easy to compress.

New

While the preferred shape is a “U” shape, it may also be in a circular as in Sketch 6, oblong, or rectangular shape with or without the 90 degree bend.

1. We claim this special design of a tool to remove small pressure fitted light bulbs from their base.
It is uniquely shaped to fit easily into one's hand and allows for easy removing and changing of pressure fitted bulbs.
It has a notch that fits between the plastic shoulder of the bulb and the top of the base.

2. That its shape, small form, and ease of use, will greatly aid anyone in removing small Christmas type bulbs.

3. While the preferred shape is a “U” shape, it may also be in circular, oblong. or rectangular shape with or without the 90 degree bend.
